(19) United States
(12) Patent Application Publication
(10) Pub. No.: US 2022/0036355 A1
(43) Pub. Date: Feb. 3, 2022

(54) METHODS AND DEVICES FOR PRIVACY-PRESERVING VERIFICATION OF PROFIT-SHARING BETWEEN USERS

(71) Applicant: Alipay Labs (Singapore) Pte. Ltd., Singapore (SG)

(72) Inventors: Shengjiao CAO, Singapore (SG); Hui Fang, Singapore (SG); Weitao Yang, Singapore (SG)

(73) Assignee: Alipay Labs (Singapore) Pte. Ltd.

(21) Appl. No.: 17/355,483

(22) Filed: Jun. 23, 2021

(30) Foreign Application Priority Data
Jul. 30, 2020 (SG) 10202007307Q

(51) Int. Cl. G06Q 20/40; H04L 9/00; H04L 9/32

(52) U.S. Cl. CPC G06Q 20/401; G06Q 20/405; G06Q 2220/00; H04L 9/3239; H04L 2209/38; H04L 9/008

(57) ABSTRACT

Disclosed herein are methods, devices, and apparatuses, including computer programs stored on computer-readable media, for privacy-preserving verification of profit-sharing between users. One of the methods includes: receiving computer instructions to setup a verification program for automatically determining whether a plurality of users are sharing a profit according to one or more defined rules; receiving protected transaction information, including a protected value Pᵢ representing a shared profit pᵢ in a protected format; processing the protected transaction information using the verification program to automatically determine whether the amount to be distributed to the user i is in accordance with the one or more defined rules; in response to a determination that the amount to be distributed to the user i is in accordance with the one or more defined rules, accepting the protected value Pᵢ as valid; otherwise, refusing to accept a recordation of the protected value Pᵢ.

### CROSS REFERENCE TO RELATED APPLICATION

The present application is based on and claims the benefits of priority to Singapore Patent Application No. 10202007307Q, filed Jul. 30, 2020, the entire contents of which are incorporated herein by reference.

### TECHNICAL FIELD

The specification relates generally to computer technologies, and more particularly, to methods and devices for privacy-preserving verification of profit-sharing between users.

### BACKGROUND

There are various situations where businesses may partner with each other and share or split their profits according to certain agreed rules. For example, multiple business partners may participate in transactions with customers, and these business partners may agree to share their profits made from these transactions according to certain predetermined percentages. In some situations, the business partners may use blockchain systems to record their transactions.

Blockchain systems, also known as distributed ledger systems (DLSs) or consensus systems, may enable participating parties to store data securely and immutably. Blockchain systems may include any DLSs, without referencing any particular use case, and may be used for public, private, and consortium blockchain networks. A public blockchain network is open for all entities to use the system and participate in the consensus process. A private blockchain network is provided for a particular entity, which centrally controls read and write permissions. A consortium blockchain network is provided for a select group of entities, which control the consensus process, and includes an access control layer.

A blockchain system is implemented using a peer-to-peer (P2P) network, in which the nodes communicate directly with each other, e.g., without the need of a fixed, central server. Each node in the P2P network may initiate communication with another node in the P2P network. A blockchain system maintains one or more blockchains. A blockchain is a data structure for storing data, such as transactions, that may prevent tampering and manipulation of the data by malicious parties.

Typically, data recorded on blockchains are accessible to all participating parties. This may be a concern for business partners who use a blockchain system to record their transactions because doing so would expose their transaction information, including, e.g., revenue, cost, and profit information, to various other parties participating in the blockchain system. To address these concerns, the business partners may record their transaction information in an encrypted format. However, simply encrypting their transaction information for recordation on the blockchain system would make it difficult for the blockchain system to verify whether the business partners are sharing their profits according to their agreed rules.

### SUMMARY

In one aspect, a computer-implemented method for privacy-preserving verification of profit-sharing between users includes: receiving computer instructions to setup a verification program on one or more nodes in a blockchain system for automatically determining whether a plurality of users are sharing a profit according to one or more defined rules; receiving protected transaction information, the protected transaction information including a protected value Pᵢ representing a shared profit pᵢ in a protected format, the shared profit pᵢ being an amount to be distributed to a user i of the plurality of users; processing the protected transaction information using the verification program to automatically determine whether the amount to be distributed to the user i is in accordance with the one or more defined rules; in response to a determination that the amount to be distributed to the user i is in accordance with the one or more defined rules, accepting the protected value Pᵢ as valid, wherein accepting the protected value Pᵢ as valid comprises recording the protected value Pᵢ on a blockchain; and in response to a determination that the amount to be distributed to the user i is not in accordance with the one or more defined rules, refusing to accept a recordation of the protected value Pᵢ on the blockchain.

In another aspect, a device for privacy-preserving verification of profit-sharing between users includes: one or more processors; and one or more computer-readable memories coupled to the one or more processors and having instructions stored thereon that are executable by the one or more processors to: receive computer instructions to setup a verification program on one or more nodes in a blockchain system for automatically determining whether a plurality of users are sharing a profit according to one or more defined rules; receive protected transaction information, the protected transaction information including a protected value Pᵢ representing a shared profit pᵢ in a protected format, the shared profit pᵢ being an amount to be distributed to a user i of the plurality of users; process the protected transaction information using the verification program to automatically determine whether the amount to be distributed to the user i is in accordance with the one or more defined rules; in response to a determination that the amount to be distributed to the user i is in accordance with the one or more defined rules, accept the protected value Pᵢ as valid, wherein accepting the protected value Pᵢ as valid comprises recording the protected value Pᵢ on a blockchain; and in response to a determination that the amount to be distributed to the user i is not in accordance with the one or more defined rules, refuse to accept a recordation of the protected value Pᵢ on the blockchain.

In still another aspect, a non-transitory computer-readable medium has stored therein instructions that, when executed by a processor of a device, cause the device to perform a method for privacy-preserving verification of profit-sharing between users. The method includes: receiving computer instructions to setup a verification program on one or more nodes in a blockchain system for automatically determining whether a plurality of users are sharing a profit according to one or more defined rules; receiving protected transaction information, the protected transaction information including a protected value Pᵢ representing a shared profit pᵢ in a protected format, the shared profit pᵢ being an amount to be distributed to a user i of the plurality of users; processing the protected transaction information using the verification program to automatically determine whether the amount to be distributed to the user i is in accordance with the one or more defined rules; in response to a determination that the amount to be distributed to the user i is in accordance with the one or more defined rules, accepting the protected value Pᵢ as valid, wherein accepting the protected value Pᵢ as valid comprises recording the protected value Pᵢ on a blockchain; and in response to a determination that the amount to be distributed to the user i is not in accordance with the one or more defined rules, refusing to accept a recordation of the protected value Pᵢ on the blockchain.

### BRIEF DESCRIPTION OF THE DRAWINGS

The accompanying drawings, which are incorporated in and constitute a part of this specification, illustrate embodiments. In the following description, which refers to the drawings, the same numbers in different drawings represent the same or similar elements unless otherwise represented.

FIG. 1 is a schematic diagram of a blockchain system, according to an embodiment.

FIG. 2 is a schematic diagram of a computing device for implementing a node in a blockchain system, according to an embodiment.

FIG. 3 is an illustration depicting a profit-sharing rule, according to an embodiment.

FIG. 4 is an illustration depicting relationships between commitment values, according to an embodiment.

FIG. 5 is a flow chart of a method for privacy-preserving verification of profit-sharing between users, according to an embodiment.

FIG. 6 is a flow chart of a method for privacy-preserving verification of profit-sharing between users, according to an embodiment.

FIG. 7 is a block diagram of an apparatus for privacy-preserving verification of profit-sharing between users, according to an embodiment.

### DETAILED DESCRIPTION

Embodiments of the specification provide methods and devices for privacy-preserving verification of profit-sharing between users. The methods and devices may utilize commitment schemes to protect transaction information, including, e.g., revenue, cost, and profit information. The methods and devices may also utilize a blockchain system to record the protected transaction information. If the protected transaction information concerns profit-sharing among multiple users (e.g., business partners who agreed to share profits according to certain rules), the methods and devices may also utilize the blockchain system to verify whether the users are sharing the profits according to the agreed rules. In this manner, the methods and devices can ensure that the transaction information is protected while simultaneously enforcing the profit-sharing rules.

Embodiments disclosed in the specification have one or more technical effects. In some embodiments, the methods and devices set up a verification program for automatically determining whether a plurality of users are sharing a profit according to one or more defined rules, and processing protected transaction information using the verification program. This allows the methods and devices to protect transaction information, including, e.g., revenue, cost, and profit information and preserve user privacy. In some embodiments, the methods and devices protect the transaction information using a commitment scheme. This allows the methods and devices to operate on the protected transaction information (e.g., the commitment values) to verify whether the users are sharing profits according to their agreed rules. In some embodiments, the methods and devices support recordation and verification of the protected transaction information using a blockchain system. This allows the methods and devices to store the protected transaction information in a data structure that can prevent tampering and manipulation by malicious parties. This also allows the methods and devices to utilize the blockchain system to verify the validity of the protected transaction information without revealing any private or sensitive information to the public.

A blockchain is a data structure that stores data, e.g., transactions, in a way that may prevent tampering and manipulation of the data by malicious parties. The transactions stored in this manner may be immutable and subsequently verified. A blockchain includes one or more blocks. Each block is linked to a previous block immediately before it in the blockchain by including a cryptographic hash of the previous block. Each block also may include a timestamp, its own cryptographic hash, and one or more transactions. The transactions, which generally have already been verified by the nodes of the blockchain system, may be hashed and encoded into a data structure, such as a Merkle tree. In a Merkle tree, data at leaf nodes of the tree is hashed, and all hashes in each branch of the tree may be concatenated at a root of the branch. This process continues up the tree to the root of the entire tree, which stores a hash that is representative of all data in the tree. A hash purporting to be of a transaction stored in the tree can be quickly verified by determining whether it is consistent with the structure of the tree.

A blockchain system includes a network of computing nodes that manage, update, and maintain one or more blockchains. The network may be a public blockchain network, a private blockchain network, or a consortium blockchain network. For example, numerous entities, such as hundreds, thousands, or even millions of entities, can operate in a public blockchain network, and each of the entities operates at least one node in the public blockchain network. Accordingly, the public blockchain network can be considered a public network with respect to the participating entities. Sometimes, a majority of entities (nodes) must sign every block for the block to be valid and added to the blockchain of the blockchain network. Examples of public blockchain networks include particular peer-to-peer payment networks that leverage a distributed ledger, referred to as blockchain.

In general, a public blockchain network may support public transactions. A public transaction is shared with all of the nodes in the public blockchain network, and is stored in a global blockchain. A global blockchain is a blockchain replicated across all nodes, and all nodes are in perfect state consensus with respect to the global blockchain. To achieve consensus (e.g., agreement to the addition of a block to a blockchain), a consensus protocol is implemented in the public blockchain network. Examples of consensus protocols include proof-of-work (POW) (e.g., implemented in the some crypto-currency networks), proof-of-stake (POS), and proof-of-authority (POA).

In general, a private blockchain network may be provided for a particular entity, which centrally controls read and write permissions. The entity controls which nodes are able to participate in the blockchain network. Consequently, private blockchain networks are generally referred to as permissioned networks that place restrictions on who is allowed to participate in the network, and on their level of participation (e.g., only in certain transactions). Various types of access control mechanisms can be used (e.g., existing participants vote on adding new entities, a regulatory authority can control admission).

In general, a consortium blockchain network may be private among the participating entities. In a consortium blockchain network, the consensus process is controlled by an authorized set of nodes, one or more nodes being operated by a respective entity (e.g., a financial institution, insurance company). For example, a consortium of ten (10) entities (e.g., financial institutions, insurance companies) can operate a consortium blockchain network, each of which operates at least one node in the consortium blockchain network. Accordingly, the consortium blockchain network can be considered a private network with respect to the participating entities. In some examples, each entity (node) must sign every block in order for the block to be valid, and added to the blockchain. In some examples, at least a sub-set of entities (nodes) (e.g., at least 7 entities) must sign every block in order for the block to be valid, and added to the blockchain.

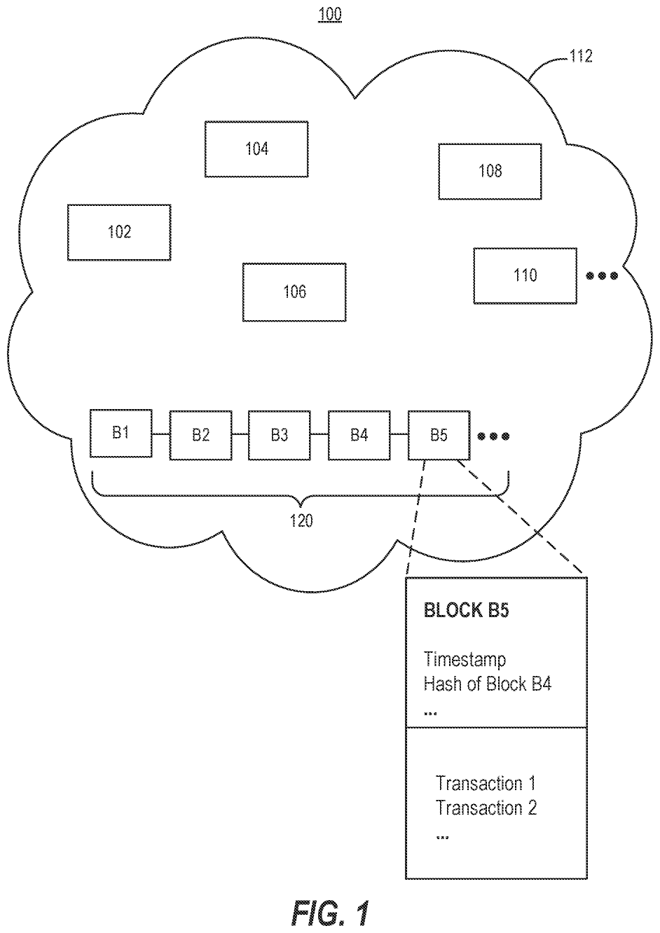

FIG. 1 illustrates a schematic diagram of a blockchain system 100, according to an embodiment. Referring to FIG. 1, the blockchain system 100 may include a plurality of nodes, e.g., nodes 102-110, configured to operate on a blockchain 120. The nodes 102-110 may form a network 112, such as a peer-to-peer (P2P) network. Each of the nodes 102-110 may be a computing device, such as a computer or a computer system, configured to store a copy of the blockchain 120, or may be software running on the computing device, such as a process or an application. Each of the nodes 102-110 may have a unique identifier.

The blockchain 120 may include a growing list of records in the form of data blocks, such as blocks B1-B5 in FIG. 1. Each of the blocks B1-B5 may include a timestamp, a cryptographic hash of a previous block, and data of the present block, which may be transactions such as monetary transactions. For example, as illustrated in FIG. 1, block B5 may include a timestamp, a cryptographic hash of block B4, and transaction data of block B5. Also, for example, a hashing operation may be performed on the previous block to generate the cryptographic hash of the previous block. The hashing operation may convert inputs of various lengths into cryptographic outputs of a fixed length through a hash algorithm, such as SHA-256.

The nodes 102-110 may be configured to perform an operation on the blockchain 120. For example, when a node, e.g., the node 102, wants to store new data onto the blockchain 120, that node may generate a new block to be added to the blockchain 120 and broadcast the new block to other nodes, e.g., the nodes 104-110, in the network 112. Based on legitimacy of the new block, e.g., validity of its signature and transactions, the other nodes may determine to accept the new block, such that the node 102 and the other nodes may add the new block to their respective copies of the blockchain 120. As this process repeats, more and more blocks of data may be added to the blockchain 120.

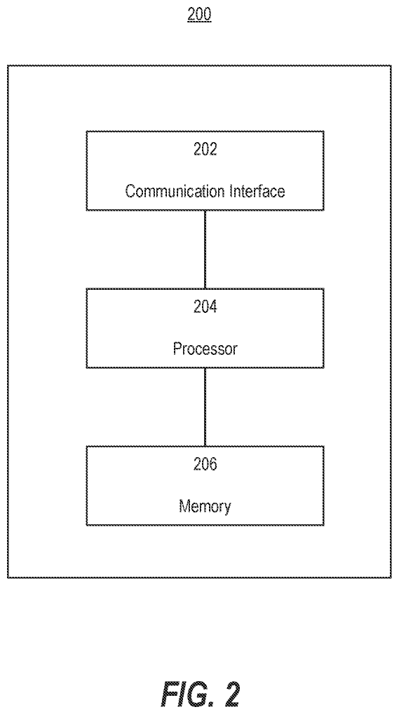

FIG. 2 illustrates a schematic diagram of a computing device 200 for implementing a node, e.g., the node 102 (FIG. 1), in a blockchain system, according to an embodiment. Referring to FIG. 2, the computing device 200 may include a communication interface 202, a processor 204, and a memory 206.

The communication interface 202 may facilitate communications between the computing device 200 and devices implementing other nodes, e.g., nodes 104-110 (FIG. 1), in the network. In some embodiments, the communication interface 202 is configured to support one or more communication standards, such as an Internet standard or protocol, an Integrated Services Digital Network (ISDN) standard, etc. In some embodiments, the communication interface 202 may include one or more of a Local Area Network (LAN) card, a cable modem, a satellite modem, a data bus, a cable, a wireless communication channel, a radio-based communication channel, a cellular communication channel, an Internet Protocol (IP) based communication device, or other communication devices for wired and/or wireless communications. In some embodiments, the communication interface 202 may be based on public cloud infrastructure, private cloud infrastructure, hybrid public/private cloud infrastructure.

The processor 204 may include one or more dedicated processing units, application-specific integrated circuits (ASICs), field-programmable gate arrays (FPGAs), or various other types of processors or processing units. The processor 204 is coupled with the memory 206 and is configured to execute instructions stored in the memory 206.

The memory 206 may store processor-executable instructions and data, such as a copy of the blockchain 120 (FIG. 1). The memory 206 may include any type of volatile or non-volatile memory devices, or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, or a magnetic or optical disk. When the instructions in the memory 206 are executed by the processor 204, the computing device 200 may perform an operation on the blockchain 120.

Users of a blockchain system, e.g., the blockchain system 100, may utilize the blockchain system 100 to record various types of transactions. For example, two or more users may partner with each other and offer to sell to a customer a product, the delivery of which may be insured by an insurer. The customer may pay a specified amount, referred to as the revenue r, to a trading platform, which may deduct the cost of insurance, denoted as the cost c, payable to the insurer. The remaining amount, r−c, referred to as the profit p in this example, may be shared by the users according to certain predetermined rules. In some embodiments, the users may record their transaction information, including, e.g., revenue, cost, and profit information on a blockchain, e.g., the blockchain 120, maintained in the blockchain system 100. As will be further described below, in some embodiments, the users may record their transaction information in a protected format to preserve their privacy.

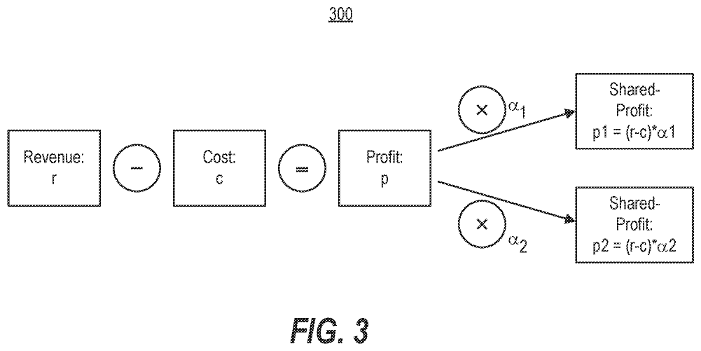

In some embodiments, the users may agree to share the profit p according to certain predetermined rules. FIG. 3 illustrates a sample profit-sharing rule 300 for sharing the profit p between two users. As shown in FIG. 3, to share the profit p between two users, the two users may agree that the first user will receive p₁=(r−c)×α₁ and the second user will receive p₂=(r−c)×α₂, where α₁ and α₂ may be pre-determined sharing factors and α₁+α₂ may equal to 1. In some embodiments, the first user may be a product manufacturer and the second user may be a financial service provider who partners with the first user to facilitate the trade with a customer. In some embodiments, the first user may be a manufacturer responsible for manufacturing certain portions of the product and the second user may be another manufacture responsible for manufacturing remaining portions of the product. It is to be understood that there may be various reasons for the users to partner with each other.

It is also to be understood that more than two users may partner together. For example, for a partnership of N users, the N users may agree to profit-sharing rules defined as:

$${p}_{1} = ( r - c ) \times {α}_{1} \\ {p}_{2} = ( r - c ) \times {α}_{2}$$

$$…$$

$${p}_{N} = ( r - c ) \times {α}_{N} ,$$

where α₁, α₂, . . . α_{N} are the N sharing factors for the N users, and the sum of α₁, α₂, . . . α_{N} may equal to 1.

It is to be understood that the profit-sharing rules described above are merely presented as examples and are not meant to be limiting. The revenue r, the cost c, and the calculation of the profit p described above are also merely presented as examples and are not meant to be limiting. For example, in some embodiments, the cost c may account for material costs and service costs in addition to (or instead of) the cost of insurance described above. The users may also agree to determine the revenue r, the cost c, and the profit p in various ways, and define or adjust their profit-sharing rules accordingly.

In some embodiments, the users may agree to record their profit-sharing rules on the blockchain 120 so that the blockchain system 100 can verify whether the users are sharing their profits according to the rules they agreed to. In some embodiments, the blockchain 120 may utilize one or more smart contracts executing on the blockchain 120 to provide the verification. Smart contracts are computer protocols implemented in the form of computer code that are incorporated into the blockchain 120, to facilitate, verify, or enforce the negotiation or performance of contracts. For example, the users of the blockchain 120 may program agreed terms (e.g., the profit-sharing rules) into a smart contract using a programming language, such as C++, Java, Solidity, Python, etc., and use the smart contract to verify whether the users are sharing their profits according to the agreed terms. Also for example, the smart contract may include a plurality of subroutines or functions, each of which may be a sequence of program instructions that performs a specific task. The smart contract may be operational code that is fully or partially executed without human interaction.

In some embodiments, the blockchain 120 may accept a smart contract defining profit-sharing rules if all users who are parties to the profit-sharing rules indicate that they agree with the terms expressed in the smart contract. For example, the users may indicate that they agree with the terms expressed in the smart contract by signing the smart contract using their private key. In another example, the users may indicate that they agree with the terms expressed in the smart contract by submitting a copy of the smart contract for recordation on the blockchain 120. In still another example, the users may indicate that they agree with the terms expressed in the smart contract to an administrator (or a trusted authority), and the administrator may submit the smart contract to the blockchain 120 after having determined all users who are parties to profit-sharing rules have indicate to the administrator that they agree with the terms expressed in the smart contract.

In some embodiments, the users may agree to record their transaction information, including, e.g., the values of r, c, and p₁, p₂, . . . p_{N}, on the blockchain 120. In this manner, the blockchain 120, e.g., by executing a smart contract recorded therein, may verify whether the users are sharing their profits according to their profit-sharing rules by verifying whether pᵢ=(r−c)×αᵢ holds true for all i∈1 . . . N.

In some embodiments, the users may wish to preserve their privacy and request the blockchain 120 to perform the verification without submitting the plaintext values of r, c, and p₁, p₂, . . . p_{N} to the blockchain 120. In such embodiments, the users may agree to protect their transaction information and submit the protected transaction information instead of the plaintext values to the blockchain 120.

In some embodiments, the users may protect the transaction information, including, e.g., the plaintext values of r, c, and p₁, p₂, . . . p_{N}, using a commitment scheme. For example, instead of submitting the values of r, c, and p₁, p₂, . . . p_{N} to the blockchain 120, the users may submit the protected values R=comm(r), C=comm(c), and Pᵢ=comm(pᵢ) for i∈1 . . . N. In some embodiments, the commitment scheme used to calculate the protected values R, C, and Pᵢ may be additively homomorphic, which means that for a particular value x and a particular value y, the commitment scheme provides that comm(x)⊕comm(y) equals comm(x+y), where ⊕ denotes a type of algebraic operation (e.g., addition or multiplication) that can be performed on comm(x) and comm(y). In some embodiments, the commitment scheme used may be a Pedersen commitment scheme, e.g., as disclosed in Torben Pryds Pedersen, “Non-Interactive and Information-Theoretic Secure Verifiable Secret Sharing,” Advances in Cryptology—CRYPTO 91 Procs., Lecture Notes in Computer Science, vol. 576, pp. 129-140, 1991, which is herein incorporated by reference in its entirety. The Pedersen commitment of a value v may be expressed as PC(v,rn_{b})=g^{v}h^{rn}^{ᵥ}, where PC( ) denotes Pedersen commitment, v denotes the value for which the Pedersen commitment is calculated, rnᵥ is a random number used to generate the Pedersen commitment of the value v, and g and h are generator values. The Pedersen commitment scheme is additively homomorphic, meaning that PC(x,rnₓ)PC(y,rn_{y})=PC(x+y,rnₓ+rn_{y}).

Continuing with the example above, using the Pedersen commitment scheme, the users may calculate the protected value R as PC(r,rnᵣ)=g^{r}h^{rn}^{ᵣ}, the protected value C as PC(c,rn_{c})=g^{c}h^{rn}^{_{c}}, and the protected value Pᵢ as PC(pᵢ,rnₚᵢ)=g^{Pi}h^{rn}pi.

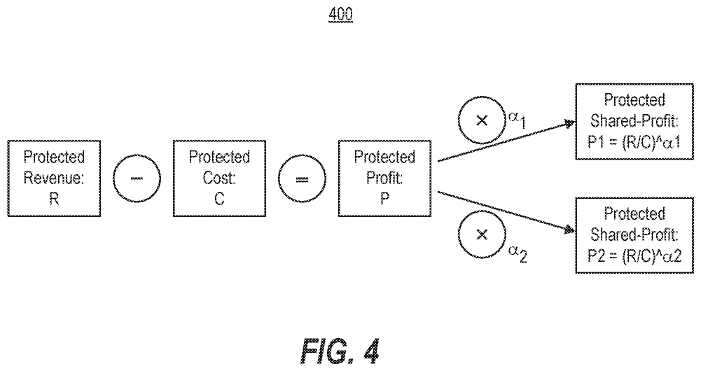

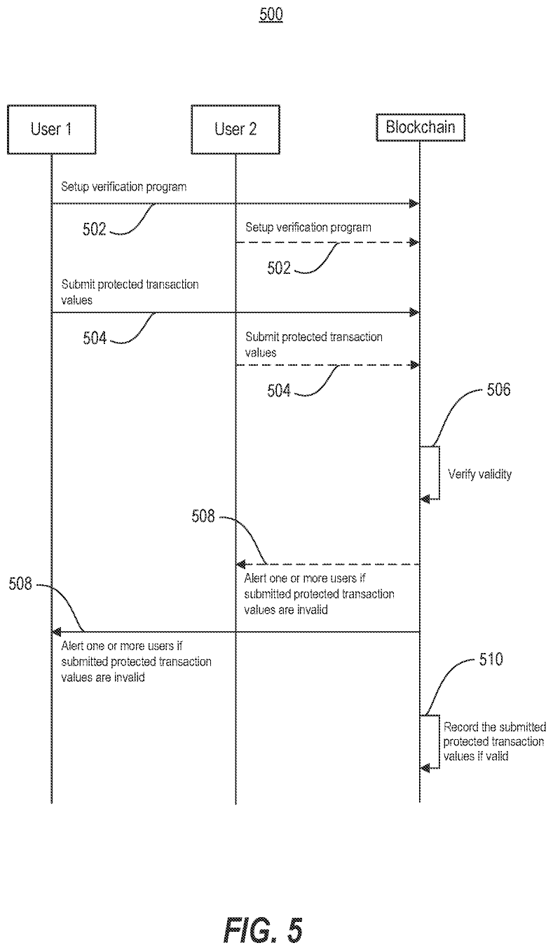

Because the Pedersen commitment scheme is additively homomorphic, the profit-sharing rule described above, e.g., pᵢ=(r−c)×αᵢ, indicate that Pᵢ should equal to (R/C)^{α}^{ᵢ}, as illustrated in a relationship diagram 400 depicted in FIG. 4. In this manner, even if the users withhold the plaintext values of r, c, and pᵢ, and only submit the protected values R, C, and Pᵢ to the blockchain 120 for recordation, the blockchain 120, e.g., by executing a smart contract recorded therein, may still be able to verify whether the users are sharing their profits according to their agreed rules by determining whether Pᵢ=(R/C)^{α}^{ᵢ} holds true for all i∈1 . . . N. This verification process is further described below in connection with FIG. 5.

FIG. 5 illustrates a flow chart of a method 500 for privacy-preserving verification of profit-sharing, according to an embodiment. For illustrative purposes, a Blockchain, e.g., the blockchain 120 (FIG. 1), and two users, a User 1 and a User 2, are depicted in FIG. 5. The Blockchain may be implemented to support various types of users, or parties, including, e.g., individuals, businesses, banks, financial institutions, insurance agencies, trading platforms, hospitals, as well as other types of companies, organizations, and the like.

In some embodiments, the Users 1 and 2 may agree to share a profit p, calculated as revenue r minus cost c, according to profit-sharing rules. For example, the User 1 may agree to receive p₁=(r−c)×α₁ and the User 2 may agree to receive p₂=(r−c)×α₂, where α₁ and α₂ are pre-determined sharing factors and α₁+α₂=1. In some embodiments, the Users 1 and 2 may agree to record their profit-sharing rules on the Blockchain so that the Blockchain can verify whether they are sharing their profits according to the rules they agreed to.

At step 502, either the User 1, the User 2, or both, may setup a verification program on the Blockchain. Alternatively, in some embodiments, the Users 1 and 2 may agree to choose an administrator (or a trusted authority on the Blockchain, not shown in FIG. 5) to setup the verification program on the Blockchain for them. In some embodiments, the verification program may be implemented as a smart contract, which may be utilized to determine whether the Users 1 and 2 are sharing their profits according to their agreed rules. Continuing with the example above, in some embodiments, the smart contract may be defined to include definitions of the sharing factors α₁ and α₂ (or more generally, αᵢ). The smart contract may also be defined to receive input values from one or more users. The input values may include, e.g., the protected values R, C, P₁, and P₂ (or more generally, Pᵢ).

In some embodiments, once the smart contract is setup, the Users 1 and 2 may conduct their businesses in a manner as they wish, with or without using the Blockchain. However, when a user, e.g., user i, decides to take its share of the profit from the partnership, that user i may be required to submit, at step 504, a set of protected values to the Blockchain for verification. In some embodiments, the set of protected values to be submitted to the Blockchain for verification may include the protected values R, C, and the protected value Pᵢ (which is the protected value of profit pᵢ user i wants to take). In some embodiments, the user submitting the protected values R, C, and Pᵢ may use a commitment scheme, e.g., the Pedersen commitment scheme described above, to calculate the protected values R, C, and Pᵢ.

In some embodiments, each user i may be responsible for calculating its own protected value Pᵢ for submission to the Blockchain. Additionally, or alternatively, one or more users may calculate protected values P₁, P₂, . . . P_{N} for i∈1 . . . N and submit the protected values P₁, P₂, . . . P_{N} to the Blockchain. In some embodiments, the users may decide whether they should calculate only their own protected value Pᵢ, or they should calculate protected values Pᵢ of other users, e.g., based on an agreement of the users.

In some embodiments, the Blockchain may receive the protected values R, C, and Pᵢ from additional or alternative sources. For example, if the User 1 partnered with the User 2 to sell to a customer a product, the delivery of which was insured by an insurer, then the customer who paid the specified price r for the product may calculate the protected value R, and if the customer is a user of the Blockchain, the customer may submit the protected value R to the Blockchain. Similarly, the insurer who charged the cost of insurance, which is the value of c in this example, may calculate the protected value C, and if the insurer is a user of the Blockchain, the insurer may submit the protected value C to the Blockchain. Furthermore, if the customer purchased the product through a trading platform, the trading platform may know the values of r and c, and if the trading platform (or the organization providing the trading platform) is a user of the Blockchain, the trading platform may calculate the protected values R and C and submit the protected values R and C to the Blockchain. In addition, if the trading platform also handles distributions of profits, then the trading platform may know the value of pᵢ claimed by user i. The trading platform may calculate the protected value Pᵢ and submit the protected value Pᵢ to the Blockchain.

It is to be understood that the references to the customer, the insurer, and the trading platform described above are merely presented as examples and are not meant to be limiting. Other users who may have abilities to calculate the protected values R, C, and P₁ and submit these protected values to the Blockchain in similar manners. In some embodiments, the submissions of the protected values may be accompanied by one or more identifiers for identifying the purchases made, the products sold, the transactions conducted, or the users involved (e.g., the Users 1 and 2 in the example above). In this manner, the relationships between the protected values R, C, and Pᵢ submitted to the Blockchain may be established and utilized to verify whether the users (e.g., the Users 1 and 2) are sharing their profits according to the agreed terms.

At step 506, the Blockchain may verify whether a user, e.g., user i, is sharing its profits according to the agreed rules by determining whether Pᵢ=(R/C)^{α}^{ᵢ} holds true. In some embodiments, the Blockchain may repeat the verification process for multiple users. In some embodiments, the Blockchain may determine whether Pᵢ=(R/C)^{α}^{ᵢ} holds true for all i∈1 . . . N. In some embodiments, the Blockchain may utilize one or more smart contracts executing on the Blockchain to perform the verification. In some embodiments, the one or more smart contracts used to perform the verification include the smart contract setup at step 502.

In some embodiments, if the Blockchain determines that Pᵢ≠(R/C)^{α}^{ᵢ} for a particular user i, then the Blockchain may determine that this particular user i is attempting to take an amount of profit pᵢ that does not equal to (r−c)×αᵢ. It is noted that the Blockchain can make this determination without knowing the plaintext values of r, c, and pᵢ, thereby preserving user privacy.

In some embodiments, if the Blockchain determines that a particular user i is attempting to take an amount of profit pᵢ≠(r−c)×αᵢ, the Blockchain may consider user i's action to be invalid, and at step 508, may send an alert to user i notifying user i of the determination. In some embodiments, the Blockchain may send one or more alerts to one or more other users, including, e.g., user i's partners, informing them of user i's invalid action. In some embodiments, the Blockchain may refuse to accept the transaction submitted by user i until user i submits a corrected value Pᵢ so that Pᵢ=(R/C)^{α}^{ᵢ} holds true. In some embodiments, the Blockchain may take additional or alternatively security measures to prevent user i from performing any actions that the Blockchain determines to be invalid or not in accordance with the profit-sharing rules. On the other hand, if the Blockchain accepts user i's action as a valid action, the Blockchain may, at step 510, record the transaction submitted by user i (e.g., record the transaction submitted by the User 1 at step 504). In this manner, only verified transactions are recorded on the Blockchain, enhancing data security without compromising user privacy.

It is to be understood that the method 500 for providing privacy-preserving profit sharing and verification may be utilized by users of the Blockchain regardless of whether the users record their banking information on the Blockchain. For example, if a user, e.g., user i, records its banking information on the Blockchain, the Blockchain may take security measures described above to further prevent user i from attempting to record financial transactions involving user i's shared profit on the Blockchain (e.g., prevent the User 1 from attempting to record a transfer of a share of a profit from a trading platform to the User 1's bank account) unless the Blockchain has accepted user i's action as a valid action. In another example, even if user i does not record its banking information on the Blockchain, user i and its partners may still utilize the method 500 to facilitate privacy-preserving profit sharing and verification. In such cases, user i and its partners may still benefit from the method 500 because they may be able to determine whether they have received the correct shares of the profit. User i and its partners may make such determinations by observing whether the Blockchain refused to accept recordation of any protected values or issued any alerts.

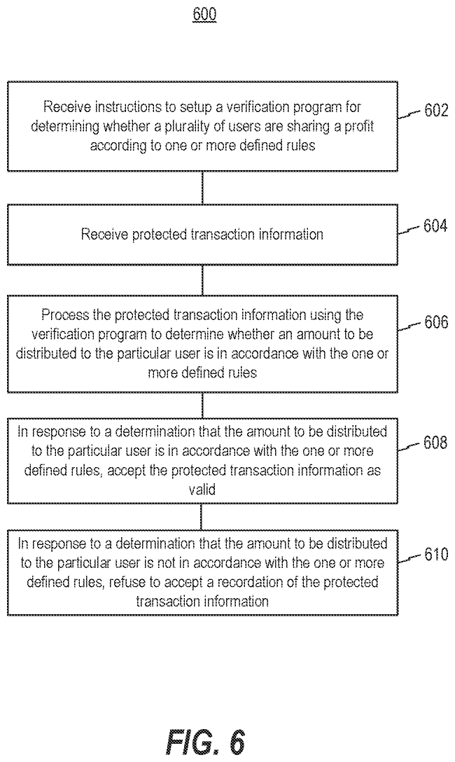

FIG. 6 illustrates a flow chart of a method 600 for privacy-preserving verification of profit-sharing between users, according to an embodiment. The method 600 may be performed by one or more nodes in a blockchain system, e.g., the nodes 102-110 in the blockchain system 100 (FIG. 1). The nodes 102-110 in the blockchain system 100 may perform operations on a blockchain, e.g., the blockchain 120 (FIG. 1). The blockchain 120 may be implemented as the Blockchain in the examples described above.

At step 602, a node, e.g., the node 102, may receive instructions to setup a verification program for automatically determining whether one or more users are sharing a profit according to one or more defined rules. The users may include, e.g., the Users 1 and 2 (FIG. 5). In some embodiments, the node 102 may receive instructions to setup the verification program from one or more users. In some embodiments, the users may agree to choose an administrator (or a trusted authority) to send instructions to the node 102 to setup the verification program. In some embodiments, the verification program may be implemented as a smart contract. In some embodiments, the smart contract may be defined to include definitions of sharing factors α₁ and α₂ (or more generally, αᵢ) for the Users 1 and 2 (or more generally, user i). The smart contract may also be defined to receive input values from one or more users.

At step 604, the node 102 may receive protected transaction information, which may include a protected revenue R representing a plaintext value of a revenue r in the protected format. The protected transaction information may also include a protected cost C representing a plaintext value of a cost c in the protected format. The protected transaction information may further include a protected value Pᵢ representing a plaintext value of a shared profit pᵢ in the protected format. As described above, the shared profit pᵢ may represent an amount to be distributed to a particular user i (or the amount user i claims to be its share of the profit).

In some embodiments, the node 102 may receive the protected transaction information from one or more users who are sharing the profit. Additionally, or alternatively, the node 102 may receive the protected transaction information from other sources, including, e.g., a customer, an insurer, a trading platform, and the like, as described above. In some embodiments, the protected values R, C, and Pᵢ may be the commitment values of r, c, and pᵢ, respectively. In some embodiments, the protected values R, C, and Pᵢ may be calculated based on an additively homomorphic commitment scheme, such as the Pedersen commitment scheme. In some embodiments, the node 102 may receive the protected values R, C, and Pᵢ without receiving the values of r, c, and pᵢ.

At step 606, the node 102 may process the protected transaction information using the verification program to automatically determine whether the amount to be distributed to the particular user i is in accordance with the one or more defined rules. In some embodiments, the node 102 may determine that the amount to be distributed to the user i is in accordance with the one or more defined rules if Pᵢ=(R/C)^{α}^{ᵢ}. In this manner, the node 102 may determine whether the amount to be distributed to the particular user i is in accordance with the one or more defined rules without knowing the plaintext values of r, c, and pᵢ, thereby preserving user privacy.

At step 608, the node 102 may, in response to a determination that the amount to be distributed to the particular user i is in accordance with the one or more defined rules, accept the protected value Pᵢ as a valid record. On the other hand, if the amount to be distributed to the particular user i is not in accordance with the one or more defined rules, the node 102 may, at step 610, refuse to accept the recordation of the protected value Pᵢ.

In some embodiments, if the node 102 refuses to accept the recordation of the protected value Pᵢ, the node 102 may send an alert to user i notifying user i of the determination. In some embodiments, the node 102 may also send one or more alerts to one or more other users, including, e.g., user i's partners, informing them of user i's invalid action. In some embodiments, the node 102 may refuse to accept the transaction submitted by user i until user i submits a corrected value Pᵢ so that Pᵢ=(R/C)^{α}^{ᵢ} holds true. In some embodiments, the node 102 may take additional or alternatively security measures to prevent user i from performing any actions the node 102 determines to be invalid or not in accordance with the profit-sharing rules. In some embodiments, the node 102 may repeat the verification process for multiple users. In some embodiments, the node 102 may determine whether Pᵢ=(R/C)^{α}^{ᵢ} holds true for all i∈1 . . . N.

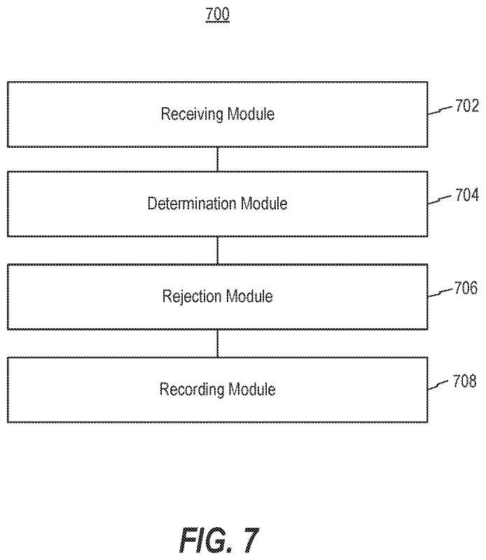

FIG. 7 is a block diagram of an apparatus 700 for privacy-preserving verification of profit-sharing between users, according to an embodiment. The apparatus 700 may be an implementation of a software process, and may correspond to the method 600 (FIG. 6). Referring to FIG. 7, the apparatus 700 may include a receiving module 702, a determination module 704, a rejection module 706, and a recording module 708.

The receiving module 702 may receive instructions to setup a verification program for automatically determining whether one or more users are sharing a profit according to one or more defined rules. In some embodiments, the receiving module 702 may receive instructions to setup the verification program from one or more users. In some embodiments, the users may agree to choose an administrator (or a trusted authority) to send instructions to the receiving module 702 to setup the verification program. In some embodiments, the verification program may be implemented as a smart contract. The receiving module 702 may also receive protected transaction information, which may include the protected values R, C, and Pᵢ described above. The receiving module 702 may provide the received protected transaction information to the determination module 704 for processing.

The determining module 704 may process the protected transaction information using the verification program to automatically determine whether the amount to be distributed to a user i is in accordance with the one or more defined rules. In some embodiments, the determining module 704 may make the determination based on the protected values R, C, and Pᵢ without knowing the plaintext values of r, c, and pᵢ, thereby preserving user privacy. In some embodiments, in response to a determination that the amount to be distributed to user i is in accordance with the one or more defined rules, the determining module 704 may accept the protected value Pᵢ as valid and provide the protected transaction information to the recording module 708, which may record the protected transaction information in a storage system. On the other hand, if the determining module 704 determines that the amount to be distributed to user i is not in accordance with the one or more defined rules, the determining module 704 may request the rejection module 706 to refuse to accept the recordation of the protected value Pᵢ. In this manner, only verified transactions may be recorded, enhancing data security without compromising user privacy.

Each of the above described modules may be implemented as software, or hardware, or a combination of software and hardware. For example, each of the above described modules may be implemented using a processor executing instructions stored in a memory. Also, for example, each the above described modules may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the described methods. Further for example, each of the above described modules may be implemented by using a computer chip or an entity, or implemented by using a product having a certain function. In one embodiment, the apparatus 700 may be a computer, and the computer may be a personal computer, a laptop computer, a cellular phone, a camera phone, a smartphone, a personal digital assistant, a media player, a navigation device, an email receiving and sending device, a game console, a tablet computer, a wearable device, or any combination of these devices.

For an implementation process of functions and roles of each module in the apparatus 700, references can be made to corresponding steps in the above-described methods. Details are omitted here for simplicity.

In some embodiments, a computer program product may include a non-transitory computer-readable storage medium having computer-readable program instructions thereon for causing a processor to carry out the above-described methods.

The computer-readable storage medium may be a tangible device that can store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

The computer-readable program instructions for carrying out the above-described methods may be assembler instructions, instruction-set-architecture (ISA) instructions, machine instructions, machine dependent instructions, microcode, firmware instructions, state-setting data, or source code or object code written in any combination of one or more programming languages, including an object oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

The computer-readable program instructions may be provided to a processor of a general-purpose or special-purpose computer, or other programmable data processing apparatus to produce a machine, such that the instructions, which execute via the processor of the computer or other programmable data processing apparatus, create means for implementing the above-described methods.

The flow charts and diagrams in the figures illustrate the architecture, functionality, and operation of possible implementations of devices, methods, and computer program products according to various embodiments of the specification. In this regard, a block in the flow charts or diagrams may represent a software program, segment, or portion of code, which comprises one or more executable instructions for implementing specific functions. It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the diagrams and/or flow charts, and combinations of blocks in the diagrams and flow charts, may be implemented by special purpose hardware-based systems that perform the specified functions or acts, or combinations of special purpose hardware and computer instructions.

It is appreciated that certain features of the specification, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

Although the specification has been described in conjunction with specific embodiments, many alternatives, modifications and variations will be apparent to those skilled in the art. Accordingly, the following claims embrace all such alternatives, modifications and variations that fall within the terms of the claims.

What is claimed is:

1. A computer-implemented method for privacy-preserving verification of profit-sharing between users, the method comprising:
receiving computer instructions to setup a verification program on one or more nodes in a blockchain system for automatically determining whether a plurality of users are sharing a profit according to one or more defined rules;
receiving protected transaction information, the protected transaction information comprising a protected value Pᵢ representing a shared profit pᵢ in a protected format, the shared profit pᵢ being an amount to be distributed to a user i of the plurality of users;
processing the protected transaction information using the verification program to automatically determine whether the amount to be distributed to the user i is in accordance with the one or more defined rules;
in response to a determination that the amount to be distributed to the user i is in accordance with the one or more defined rules, accepting the protected value Pᵢ as valid, wherein accepting the protected value Pᵢ as valid comprises recording the protected value Pᵢ on a blockchain; and
in response to a determination that the amount to be distributed to the user i is not in accordance with the one or more defined rules, refusing to accept a recordation of the protected value Pᵢ on the blockchain.

2. The method of claim 1, wherein the protected transaction information does not comprise the shared profit pᵢ.

3. The method of claim 1, wherein the verification program comprises a smart contract deployed in the blockchain system.

4. The method of claim 1, wherein the protected value Pᵢ is a commitment value of the shared profit pᵢ.

5. The method of claim 1, wherein the protected value Pᵢ is calculated based on an additively homomorphic commitment scheme.

6. The method of claim 1, wherein the protected transaction information further comprises a protected revenue R representing a revenue r in the protected format and a protected cost C representing a cost c in the protected format.

7. The method of claim 6, wherein the verification program further defines a sharing factor αᵢ for the user i.

8. The method of claim 7, wherein the processing the protected value Pᵢ using the verification program further comprises:
determining that the amount to be distributed to the user i is in accordance with the one or more defined rules when Pᵢ=(R/C)^{α}^{ᵢ}.

9. A device for privacy-preserving verification of profit-sharing between users, comprising:
one or more processors; and
one or more computer-readable memories coupled to the one or more processors and having instructions stored thereon that are executable by the one or more processors, wherein the one or more processors are configured to:
receive instructions to setup a verification program on one or more nodes in a blockchain system for automatically determining whether a plurality of users are sharing a profit according to one or more defined rules;
receive protected transaction information, the protected transaction information comprising a protected value Pᵢ representing a shared profit pᵢ in a protected format, the shared profit pᵢ being an amount to be distributed to a user i of the plurality of users;
process the protected transaction information using the verification program to automatically determine whether the amount to be distributed to the user i is in accordance with the one or more defined rules;
in response to a determination that the amount to be distributed to the user i is in accordance with the one or more defined rules, accept the protected value Pᵢ as valid, wherein accepting the protected value Pᵢ as valid comprises recording the protected value Pᵢ on a blockchain; and
in response to a determination that the amount to be distributed to the user i is not in accordance with the one or more defined rules, refuse to accept a recordation of the protected value Pᵢ on the blockchain.

10. The device of claim 9, wherein the protected transaction information does not comprise the shared profit pᵢ.

11. The device of claim 9, wherein the verification program comprises a smart contract deployed in the blockchain system.

12. The device of claim 9, wherein the protected value Pᵢ is a commitment value of the shared profit pᵢ.

13. The device of claim 9, wherein the protected value Pᵢ is calculated based on an additively homomorphic commitment scheme.

14. The device of claim 9, wherein the protected transaction information further comprises a protected revenue R representing a revenue r in the protected format and a protected cost C representing a cost c in the protected format, wherein the verification program further defines a sharing factor αᵢ for the user i, and wherein the processing the protected value Pᵢ using the verification program further comprises:
determining that the amount to be distributed to the user i is in accordance with the one or more defined rules when Pᵢ=(R/C)^{α}^{ᵢ}.

15. A non-transitory computer-readable medium having stored therein instructions that, when executed by a processor of a device, cause the device to perform a method for privacy-preserving verification of profit-sharing between users, the method comprising:
receiving computer instructions to setup a verification program on one or more nodes in a blockchain system for automatically determining whether a plurality of users are sharing a profit according to one or more defined rules;
receiving protected transaction information, the protected transaction information comprising a protected value Pᵢ representing a shared profit pᵢ in a protected format, the shared profit pᵢ being an amount to be distributed to a user i of the plurality of users;
processing the protected transaction information using the verification program to automatically determine whether the amount to be distributed to the user i is in accordance with the one or more defined rules;
in response to a determination that the amount to be distributed to the user i is in accordance with the one or more defined rules, accepting the protected value Pᵢ as valid, wherein accepting the protected value Pᵢ as valid comprises recording the protected value Pᵢ on a blockchain; and
in response to a determination that the amount to be distributed to the user i is not in accordance with the one or more defined rules, refusing to accept a recordation of the protected value Pᵢ on the blockchain.

16. The non-transitory computer-readable medium of claim 15, wherein the protected transaction information does not comprise the shared profit pᵢ.

17. The non-transitory computer-readable medium of claim 15, wherein the verification program comprises a smart contract deployed in the blockchain system.

18. The non-transitory computer-readable medium of claim 15, wherein the protected value Pᵢ is a commitment value of the shared profit pᵢ.

19. The non-transitory computer-readable medium of claim 15, wherein the protected value Pᵢ is calculated based on an additively homomorphic commitment scheme.

20. The non-transitory computer-readable medium of claim 15, wherein the protected transaction information further comprises a protected revenue R representing a revenue r in the protected format and a protected cost C representing a cost c in the protected format, wherein the verification program further defines a sharing factor αᵢ for the user i, and wherein the processing the protected value Pᵢ using the verification program further comprises:
determining that the amount to be distributed to the user i is in accordance with the one or more defined rules when Pᵢ=(R/C)^{α}^{ᵢ}.
